(19) United States
(12) Patent Application Publication
(10) Pub. No.: US 2016/0210310 A1
(43) Pub. Date: Jul. 21, 2016

(54) GEOSPATIAL EVENT EXTRACTION AND ANALYSIS THROUGH DATA SOURCES

(71) Applicant: International Business Machines Corporation, Armonk, NY (US)

(72) Inventors: Cicero Nogueira dos Santos, Rio de Janeiro (BR); Marcos R. Vieira, Rio de Janeiro (BR); Bianca Zadrozny, Rio de Janeiro (BR)

(21) Appl. No.: 14/598,776

(22) Filed: Jan. 16, 2015

(51) Int. Cl. G06F 17/30

(52) U.S. Cl. CPC G06F 17/30241; G06F 17/30342; G06F 17/30707

(57) ABSTRACT

In an approach for extracting geospatial temporal facts and events, a processor receives a set of structured data and a set of unstructured data. A processor extracts a first set of temporal information and a first set of geospatial information from the set of unstructured data. A processor identifies a second set of temporal information and a second set of geospatial information from the set of structured data. A processor determines that the set of structured data and the set of unstructured data are related, based on at least the first set of temporal information, the second set of temporal information, the first set of geospatial information, and the second set of geospatial information. A processor groups the set of structured data and the set of unstructured data into a collective set of data. A processor stores the collective set of data.

### BACKGROUND OF THE INVENTION

The present invention relates generally to the field of geospatial data and temporal logic collection and analysis and more particularly to the merger of different types of data sources.

Geospatial technology is the gathering, storing, processing, and delivering of geographical information. Location identification may be accomplished through trilateration, triangulation, or other techniques to determine a specific location. Global Positioning System (GPS) is a satellite-based navigation system made up of a network of satellites placed in orbit. GPS satellites circle the Earth and continually transmit messages to Earth that include the satellite position at the time of the message transmission.

A geographic information system (GIS) is a system designed to capture, store, manipulate, analyze, manage, and present all types of geographical data. In general, GIS describes any information system that integrates, stores, edits, analyzes, shares, and/or displays geographic information. GIS applications can allow users to create interactive queries, analyze spatial information, edit data in maps, and present the results of these operations. GIS data represents physical objects (such as roads, land use, elevation, trees, waterways, etc.), and this data may be varied based on the design of the GIS and its intended use.

Temporal logic is any system of rules and symbolism for representing and reasoning about propositions qualified in terms of time. Temporal logic allows time qualifications to be expressed by statements such as “always,” “eventually,” and “until.”

### SUMMARY

An aspect of an embodiment of the present invention discloses an approach for extracting geospatial temporal facts and events, a processor receives a set of structured data and a set of unstructured data. A processor extracts a first set of temporal information and a first set of geospatial information from the set of unstructured data. A processor identifies a second set of temporal information and a second set of geospatial information from the set of structured data. A processor determines that the set of structured data and the set of unstructured data are related, based on at least the first set of temporal information, the second set of temporal information, the first set of geospatial information, and the second set of geospatial information. A processor groups the set of structured data and the set of unstructured data into a collective set of data. A processor stores the collective set of data.

### BRIEF DESCRIPTION OF THE DRAWINGS

FIG. 1 depicts a block diagram of a computing environment, in accordance with one embodiment of the present invention.

FIG. 2 depicts a flowchart of an unstructured data source function of a geospatial program for extraction and analysis of unstructured data, in accordance with one embodiment of the present invention.

FIG. 3 depicts a flowchart of a structured data source function of a geospatial program for extraction and analysis of structured data, in accordance with one embodiment of the present invention.

FIG. 4 is a block diagram of internal and external components of the client computing device and servers of FIG. 1, in accordance with one embodiment of the present invention.

### DETAILED DESCRIPTION

Embodiments of the present invention recognize that by combining geospatial information such as the Global Positioning System (GPS) and geographic information system (GIS) with temporal information, users are able to get real time updates on events occurring at their current location, destination, or at a location in between. GPS is a satellite-based navigation system made up of a network of satellites placed in orbit. GPS satellites circle the Earth and continually transmit messages to Earth that include the satellite position at the time of the message transmission. GIS is a system designed to capture, store, manipulate, analyze, manage, and present all types of geographical data. GIS describes any information system that integrates, stores, edits, analyzes, shares, and/or displays geographic information.

Embodiments of the present invention recognize that current techniques of accessing and presenting geospatial temporal information to a user are hindered by a lack of integration of structured and unstructured data source. Embodiments of the present invention recognize that there is a need to retrieve events and/or facts from both structured and unstructured data sources and perform events and/or fact time resolution and event localization. The present invention also recognizes that there is a need to retrieve these events and/or facts and merge them with related events and/or facts from other structured or unstructured data sources, and give the merged information a score based on the accuracy, usefulness, and relevance to the search criteria.

Embodiments of the present invention extract, merge, score, and store geospatial temporal facts and/or events from structured and unstructured data sources. The stored information can then be used for advanced searches and data mining, as well as geospatial temporal analytics. Embodiments of the present invention populate a database of geospatial and temporal events, including a score that can be given to a user to assist the user in a search for an answer to a question. Embodiments of the present invention describe an end-to-end method to extract and merge geospatial temporal events and facts from structured and unstructured data sources.

The present invention will now be described in detail with reference to the Figures.

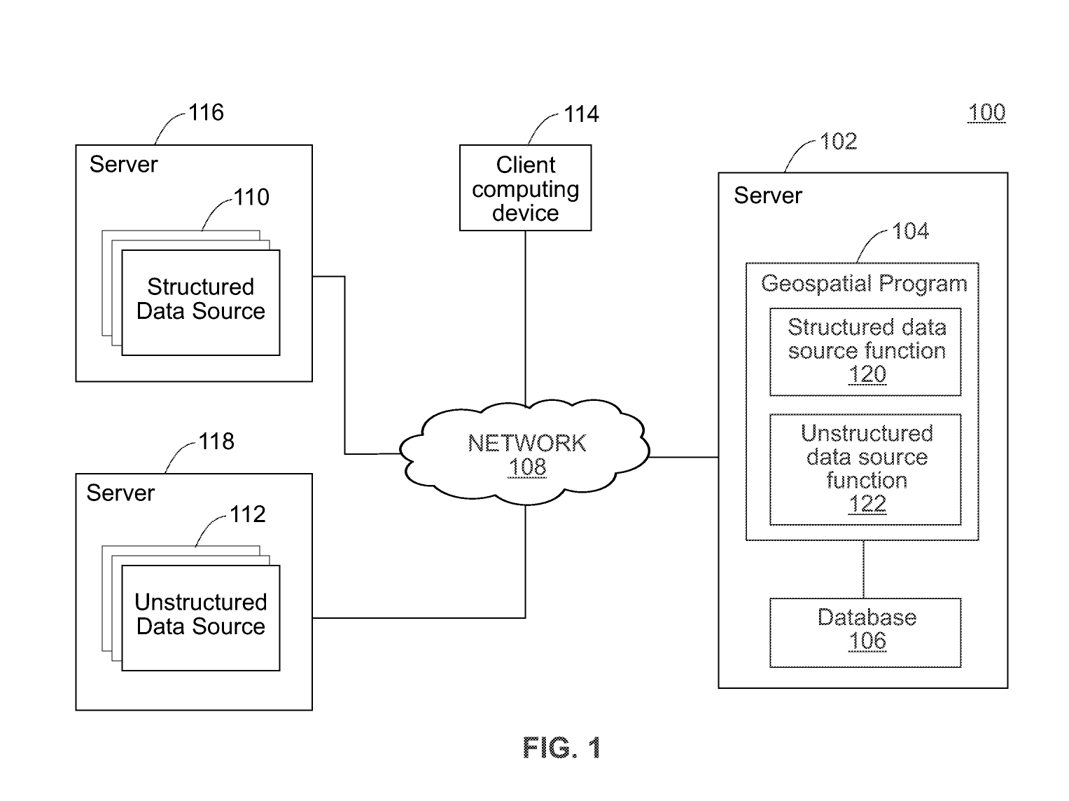

FIG. 1 depicts a block diagram of a computing environment 100 in accordance with one embodiment of the present invention. FIG. 1 provides an illustration of one embodiment and does not imply any limitations regarding the environment in which different embodiments maybe implemented. In the depicted embodiment, computing environment 100 includes server 102, server 116, and server 118 interconnected over network 108. As depicted, computing environment 100 provides an environment for geospatial program 104 to access structured data source 110 and/or unstructured data source 112 through network 108. Computing environment 100 may include additional servers, computers, or other devices not shown.

Network 108 may be a local area network (LAN), a wide area network (WAN) such as the Internet, any combination thereof, or any combination of connections and protocols that can support communications between server 102, server 116, and server 118 in accordance with embodiments of the invention. Network 108 may include wired, wireless, or fiber optic connections.

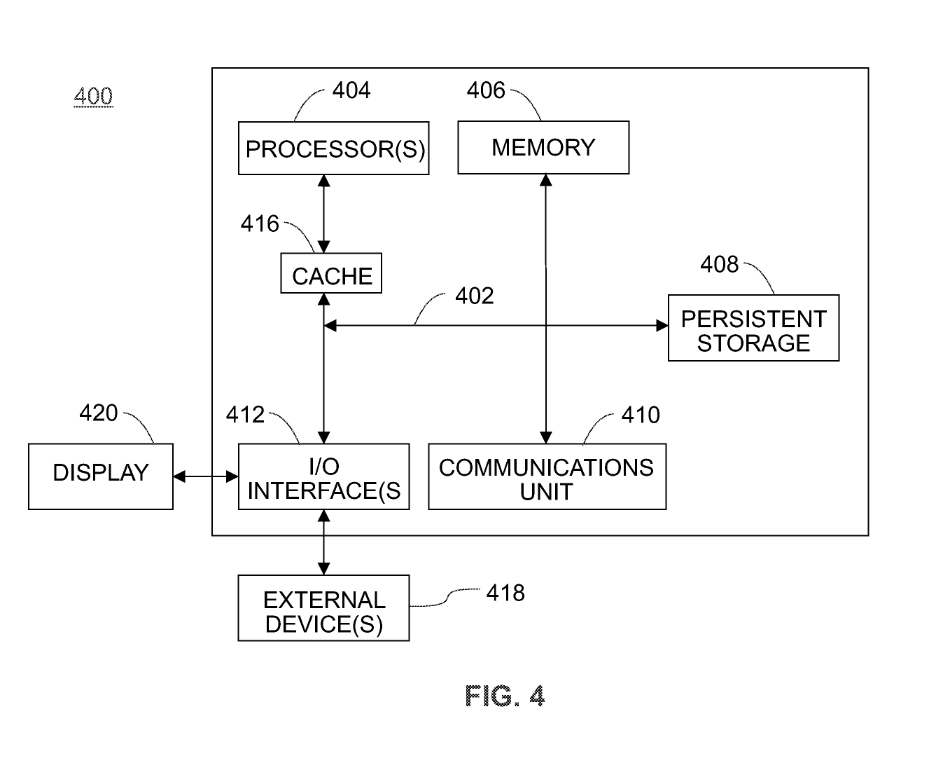

Server 102 may be a management server, a web server, or any other electronic device or computing system capable of processing program instructions and receiving and sending data. In some embodiments, server 102 may be a laptop computer, tablet computer, netbook computer, personal computer (PC), a desktop computer, or any programmable electronic device capable of communicating with server 116 and server 118 via network 108. In other embodiments, server 102 may represent a server computing system utilizing multiple computers as a server system, such as in a cloud computing environment. In another embodiment, server 102 represents a computing system utilizing clustered computers and components to act as a single pool of seamless resources. In the depicted embodiment, server 102 includes geospatial program 104, structured data source function 120, unstructured data source function 122, and database 106. In other embodiments, server 102 may include any combination of geospatial program 104, database 106, structured data source 110, and unstructured data source 112. Server 102 may include components, as depicted and described in further detail with respect to FIG. 4.

Geospatial program 104 operates to perform an analysis of structured data source 110 and unstructured data source 112. In the depicted embodiment, geospatial program 104 utilizes network 108 to access structured data source 110 and unstructured data source 112 and communicates with database 106. In one embodiment, geospatial program 104 resides on server 102. In other embodiments, geospatial program 104 may be located on another server or computing device, provided geospatial program 104 has access to database 106, structured data source 110, and/or unstructured data source 112.

Structured data source function 120 operates to analyze, categorize, and score structured data source 110, as received by geospatial program 104. In one embodiment, structured data source function 120 performs or applies a natural language assessment of structured data source 110, and applies temporal and geospatial reasoning to the structured data source 110. Structured data source function 120 extracts facts and/or events from structured data source 110 and determines if the facts and/or events are new facts and/or events. If structured data source function 120 determines a fact and/or event is not a new fact and/or event structured data source function 120 scores the fact and/or event based on how confident structured data source function 120 is on the veracity of the extracted fact and/or event and then stores the scored fact and/or event in database 106. In the depicted embodiment, structured data source function 120 is a function of geospatial program 104. In other embodiments, structured data source function 120 may be a stand-alone program located on another server, computing device, or program, provided structured data source function 120 has access to structured data source 110.

Unstructured data source function 122 operates to analyze, categorize, and score unstructured data source 112, as received by geospatial program 104. In one embodiment, unstructured data source function 122 performs or applies a natural language assessment of unstructured data source 112 and applies temporal and geospatial reasoning to the unstructured data source 112. Unstructured data source function 122 extracts facts and/or events from unstructured data source 112 and determines if the facts and/or events are new facts and/or events. If unstructured data source function 122 determines a fact and/or event is new, it is scored and added to the database 106. If unstructured data source function 122 determines a fact and/or event is not a new fact and/or event, unstructured data source function 122 rescores the previously existing fact and/or event in database 106. In the depicted embodiment, unstructured data source function 122 is a function of geospatial program 104. In other embodiments, unstructured data source function 122 may be a stand-alone program located on another server, computing device, or program, provided unstructured data source function 122 has access to unstructured data source 112.

Database 106 may be a repository that may be written to and/or read by geospatial program 104, structured data source function 120, and unstructured data source function 122. Information gathered from structured data source 110 and/or unstructured data source 112 may be stored to database 106. Such information may include geospatial temporal facts and events from structured data source 110 and/or unstructured data source 112 and scored geospatial temporal facts and events from structured data source 110 and/or unstructured data source 112. In one embodiment, database 106 is a database management system (DBMS) used to allow the definition, creation, querying, update, and administration of a database(s). In the depicted embodiment, database 106 resides on server 102. In other embodiments, database 106 resides on another server, or another computing device, provided that database 106 is accessible to geospatial program 104, structured data source 110, and unstructured data source 112.

Server 116 may be a management server, a web server, or any other electronic device or computing system capable of processing program instructions and receiving and sending data. In other embodiments, server 116 may be a laptop computer, tablet computer, netbook computer, personal computer (PC), a desktop computer, or any programmable electronic device capable of communicating with server 102 via network 108. In other embodiments, server 116 may be a server computing system utilizing multiple computers as a server system, such as in a cloud computing environment. In one embodiment, server 116 represents a computing system utilizing clustered computers and components to act as a single pool of seamless resources. In the depicted embodiment, structured data source 110 is located on server 116. Server 116 may include components, as depicted and described in further detail with respect to FIG. 4.

Structured data source 110 is information that resides in a fixed field within a record or file. Structured data depends on creating a data model, a model of the type of data that will be recorded and how the data will be stored, processed, and accessed. Creating a data model includes defining what field(s) of data will be stored and how the data will be stored therein. Data type, restrictions on data input, or other attributes to data can be used to categorize the data. Structured data has the advantage of being easily entered, stored, queried, and analyzed. Structured data is usually, but not always, managed using Structured Query Language (SQL). In the depicted embodiment, structured data source 110 is located on server 116. In other embodiments, structured data source 110 is located on another server or computing device, provided structured data source 110 is accessible to geospatial program 104 and structured data source function 120.

Server 118 may be a management server, a web server, or any other electronic device or computing system capable of processing program instructions and receiving and sending data. In other embodiments server 118 may be a laptop computer, tablet computer, netbook computer, personal computer (PC), a desktop computer, or any programmable electronic device capable of communicating via network 108. In one embodiment, server 118 may be a server computing system utilizing multiple computers as a server system, such as in a cloud computing environment. In one embodiment, server 118 represents a computing system utilizing clustered computers and components to act as a single pool of seamless resources. In the depicted embodiment unstructured data source 112 is located on server 118. Server 118 may include components, as depicted and described in further detail with respect to FIG. 4.

Unstructured data source 112 is information that either does not have a predefined data model or is not organized in a predefined manner. Unstructured information is typically text heavy, but may contain data such as dates, numbers, and facts. Unstructured information can also be photos and graphic images, videos, streaming instrument data, webpages, pdf files, blog entries, wikis, emails, word processing documents, or city, state, or national newspapers. In general, unstructured data refers to information that either does not have a predefined data model or information that is not organized in a predefined manner. In one embodiment, unstructured data source 112 can also be semi-structured data. Semi-structured data is a type of structured data but lacks a strict data model structure. In semi-structured data, tags or other types of markers may be used to identify certain elements within the data, but the data does not have a rigid structure. In the depicted embodiment, unstructured data source 112 is located on server 118. In other embodiments, unstructured data source 112 is located on another server or computing device, provided unstructured data source 112 is accessible by geospatial program 104.

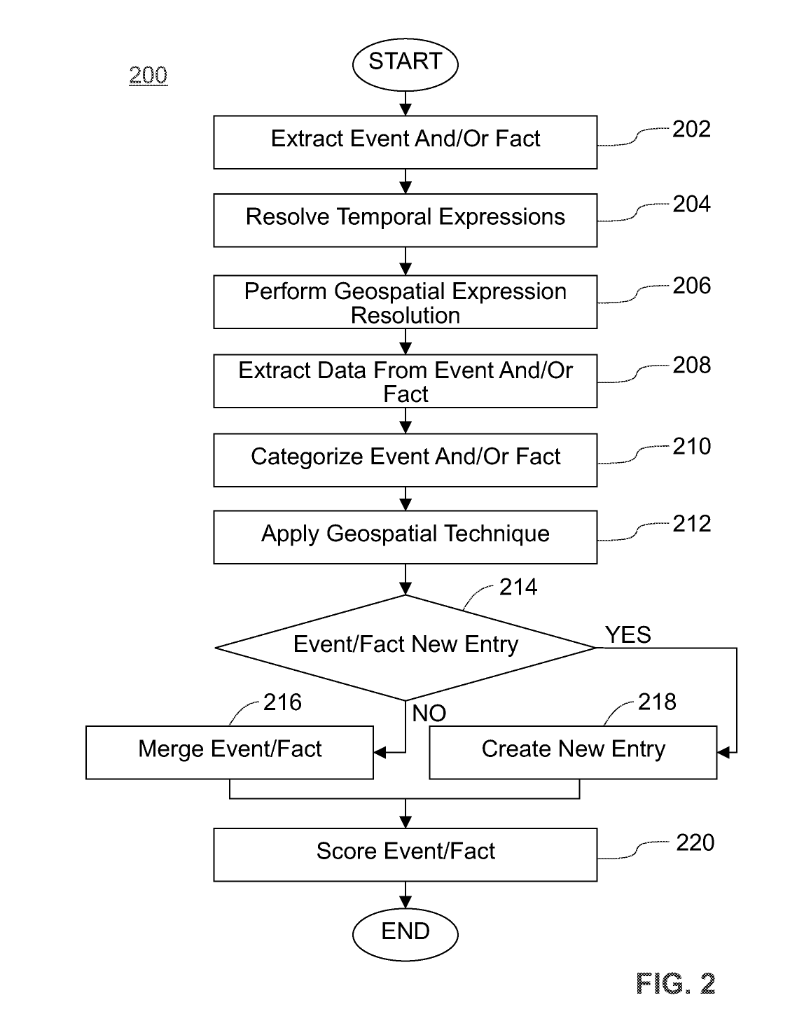

FIG. 2 depicts flowchart 200 of unstructured data source function 122, a function of geospatial program 104, executing within the computing environment 100 of FIG. 1, in accordance with an embodiment of the present invention. Unstructured data source function 122 performs an analysis on unstructured data source 112 to identify facts and/or events located within unstructured data source 112 and determine the quality, relevance, and geospatial and temporal information about the fact and/or event. After the information has been gathered and analyzed, geospatial program 104 scores or applies a confidence factor the unstructured data source 112 based on the quality of the information contained within unstructured data source 112.

In step 202, unstructured data source function 122 extracts events and/or facts from unstructured data source 112 based on, for example, a user inquiry search. It should be noted, that while unstructured data source 112 is depicted, unstructured data source function 122 may access one unstructured source or many unstructured sources. In one embodiment, unstructured data source function 122 uses natural language processing techniques to perform named entity recognition to locate and classify elements in unstructured data source 112 into predefined categories corresponding to, for example, people's names, location names, organization names, and/or other names used to identify the operator's inquiry topics. In one embodiment, unstructured data source function 122 uses tokenization as a natural language processing technique. Tokenization is a process of breaking a stream of text up into words, phrases, symbols, or other meaningful elements, referred to as tokens. A list of tokens can become input for further processing techniques, such as parsing or text mining. Parsing is the process of analyzing a string of symbols conforming to the rules of formal grammar. In one embodiment, unstructured data source function 122 uses text analytics to parse through all available events and/or facts related to the users inquiry and create topics to identify events and/or facts within the unstructured data source 112 based on keywords or common themes within these events or facts. Using natural language processing and at least one set of dictionaries and rules, unstructured data source function 122 can perform text analytics on unstructured data source 112 to identify individual events or facts within unstructured data source 112. Text analytics can be performed using an Unstructured Information Management Architecture (UIMA) application configured to analyze unstructured information to discover patterns relevant to unstructured data source function 122 by processing plain text and identifying relations. In other embodiments, unstructured data source function 122 uses part of speech tagging, shallow parsing, dependency parsing, or other natural language processing techniques. In one embodiment, unstructured data source function 122 uses keyword analysis to search unstructured data source 112 for events or facts related to the user inquiry.

In step 204, unstructured data source function 122 resolves temporal expressions in facts and/or events of unstructured data source 112. For example, unstructured data source function 122 can link time expressions in identified events and/or facts from unstructured data source 112 to a calendar date (e.g., “yesterday”, “today”, “last week”, etc.) that is relevant to when the identified events and/or facts were created. In one embodiment, unstructured data source function 122 resolves temporal expression in events and/or facts by using user defined procedures to resolve the temporal expressions from unstructured data source 112. In other embodiments, unstructured data source function 122 uses machine learning techniques to resolve the temporal expressions in facts and/or events of unstructured data source 112, or a combination of machine learning techniques and user defined procedures.

In step 206, unstructured data source function 122 performs geospatial expression resolution on each identified event or fact of unstructured data source 112. In one embodiment, unstructured data source function 122 receives each event or fact and, dependent on the location description, links the location description to a geographical location. In one embodiment, unstructured data source function 122 links the location description to a longitude and latitude. In another embodiment, unstructured data source function 122 uses geo-reference information in the events and facts of unstructured data source 112 to create the geographical location. Geographic Information System (GIS) information can be individual spatial data files representing real geographical features such as rivers, roads, vehicle theft locations, car accident locations, flooded areas, areas affected by earthquakes, and the like. Geo-reference information can be individual spatial data files representing conceptual geographic features such as zoning boundaries, parcel boundaries, city boundaries, state boundaries, country boundaries and the like. In other embodiments, unstructured data source function 122 uses other geographical methods to link the events and facts of unstructured data source 112 to geographical locations.

In step 208, unstructured data source function 122 extracts data from events and/or facts of unstructured data source 112. In one embodiment, unstructured data source function 122 extracts a relationship between events and/or facts in unstructured data source 112 through the use of domain ontology. Domain ontology defines the types, properties, and interrelationships. Domain ontology represents concepts which belong to part of the world, particular meanings of terms applied to that domain are provided by domain ontology. Examples of domain ontology entries are Portland IS_LOCATED_IN Oregon, Ipanema IS_LOCATED_IN Rio's South Zone, Ipanema IS_RELATIVELY_EASY_TO_NAVIGATE because the streets are aligned in a grid, etc. In other embodiments, unstructured data source function 122 can use other methods that can extract relevant geographic and temporal information from unstructured data source 112.

In step 210, unstructured data source function 122 performs categorization of events and/or facts by extracting variables related to an event from unstructured data source 112. In one embodiment, unstructured data source function 122 receives an identified event or fact from unstructured data source 112 and categorizes the identified event or fact into variables such as: who, what, where, when, why. In other embodiments, unstructured data source function 122 categorizes the identified event or fact into variables that are related to the event such as: event, where, and when, through a combination of user defined procedures and machine learning technology. For example, if the event is “a motorcyclist crashed his motorcycle with a taxi in Ipanema on Sunday,” unstructured data source function 122 may categorize the event into variables that are related to the event such as: EVENT—motorcycle accident, WHERE—Ipanema, Rio's South Zone, WHEN—early Sunday (date of accident). In another example, if a city newspaper article prints that a certain area of a city is closed on the weekend, unstructured data source function 122 can categorize the event into variables such as: EVENT—roadway to the beach is closed to motor vehicles, WHERE—Ipanema, WHEN—every Sunday (linking the event to a calendar of the specified year to select all Sundays that appear throughout the specified year).

In step 212, unstructured data source function 122 applies geospatial techniques to events and/or facts in unstructured data source 112 to delimit a region of the location of the event. This location or geographical feature can be actual physical entities or events or can represent features of the event and/or fact. Features are, for example, the location of an accident on a highway or a street closing due to a festival in the area. While the event and/or fact does not have a defined location, the features of the area can be used to give an approximation of the event and/or fact. In one embodiment, unstructured data source function 122 performs geospatial techniques with a set of coordinates defining the coverage region in a map of the event. In one embodiment, unstructured data source function 122 uses a GIS to locate the event. In one embodiment, unstructured data source function 122 uses geospatial metadata that is associated with an event or fact. In another embodiment, unstructured data source function 122 uses longitude and latitude to give more specific coordinates of the event. In other embodiments, unstructured data source function 122 uses other forms of geospatial recognition technology to locate the location, region, area, or boundaries of the event of unstructured data source 112 based on operator requirements.

In decision 214, unstructured data source function 122 searches database 106 for an event and/or fact that is similar to the current event or fact of an unstructured data source 112. In one embodiment, unstructured data source function 122 uses a keyword search technique to search database 106 for an event or fact of either a structured data source 110 or an unstructured data source 112. In one embodiment, unstructured data source function 122 only searches through either structured data source 110 or unstructured data source 112, but not both. In one embodiment, unstructured data source function 122 has a minimum keyword value associated with a comparison of events and facts in database 106 in order to determine if the current event or fact is new or a duplicate of an already existing event or fact. If unstructured data source function 122 determines that the event or fact is not a new entry, unstructured data source function 122 combines the event or fact with the previously stored entry (see step 216). If unstructured data source function 122 determines that the fact or event is a new entry, unstructured data source function 122 creates a new entry (see step 218).

In step 216, unstructured data source function 122 combines the current event or fact of unstructured data source 112 with an event or fact of database 106. In one embodiment, unstructured data source function 122 combines the event and/or fact that is being analyzed with the event and/or fact that has been identified as being reflective of the event and/or fact that is currently stored in database 106. In one embodiment, unstructured data source function 122 may merge many events or facts considered to correspond to existing entries into a single event or fact within database 106. In one embodiment, unstructured data source function 122 only combines events or facts of unstructured data source 112 upon receiving permission from an operator. In other embodiments, unstructured data source function 122 combines only portions of events or facts of unstructured data source 112 that unstructured data source function 122 determines are not new entries. In one embodiment, unstructured data source function 122 deletes the event or fact, rather than merging the event or fact with corresponding events or facts already stored in database 106.

In step 218, unstructured data source function 122 creates a new entry in database 106. In one embodiment, unstructured data source function 122 creates a new event or fact in database 106 that contains all the relevant data regarding the event or fact that was analyzed. The relevant information may include, for example, geospatial information, temporal information, or any other information that is important for unstructured data source function 122 to access the event and/or fact. In one embodiment, unstructured data source function 122 requires operator confirmation prior to creating a new event or fact of an unstructured data source 112 in database 106. In other embodiments, unstructured data source function 122 stores the new entry in another database or location.

In step 220, unstructured data source function 122 assigns a score or confidence factor is applied to each event or fact that is either merged with an already existing event or fact in database 106 or to each new event or fact that is added to database 106. In one embodiment, this score or confidence factor indicates a likelihood of accuracy of information. In one embodiment, unstructured data source function 122 scores or applies a confidence factor to each event or fact to create a hierarchy of events or facts within database 106. This hierarchy is used by geospatial program 104 to access events or facts that are more relevant, accurate, or appear more frequently quicker. In one embodiment, geospatial program 104 begins use events or facts with a higher score first, thus geospatial program 104 will have a faster search through database 106. In one embodiment, unstructured data source function 122 scores the event or fact with the use of logistic regression. Logistic regression is a type of probabilistic statistical classification model that is used to predict an outcome variable that is categorical from predictor variables that are continuous and/or categorical. Logistic regression predicts the probability of an outcome occurring; here, that outcome is the likelihood that this event or fact is a beneficial answer to the search query. In one embodiment, the score of the event or fact is based on the uncertainty of unstructured data source 112. The uncertainty of unstructured data source 112 is based on the accuracy and reliability of the source. In other embodiments, unstructured data source function 122 determines a score of an event or fact by the frequency or number of occurrences of the event or fact in database 106, reputation of unstructured data source 112, corroboration of data, number of similar reports, accuracy of methods used in the data extraction process, amount of detail in the reports, and/or other factors. Unstructured data source function 112 adjusts the score or confidence factor based off the redundancy or occurrences of the event or fact that are already stored in database 106. In one embodiment, unstructured data source function 122 automatically stores events or facts in database 106, regardless of score. In one embodiment, unstructured data source function 122 has a minimum score that, if failed to be met, results in unstructured data source function 122 refraining from adding the corresponding event or fact to database 106. In another embodiment, unstructured data source function 122 has a minimum score that, if failed to be met, results in unstructured data source function 122 adding the event or fact to database 106, but unstructured data source function 122 also sends an alert or warning to an operator to, for example, inform the operator of the new event or fact added to database 106.

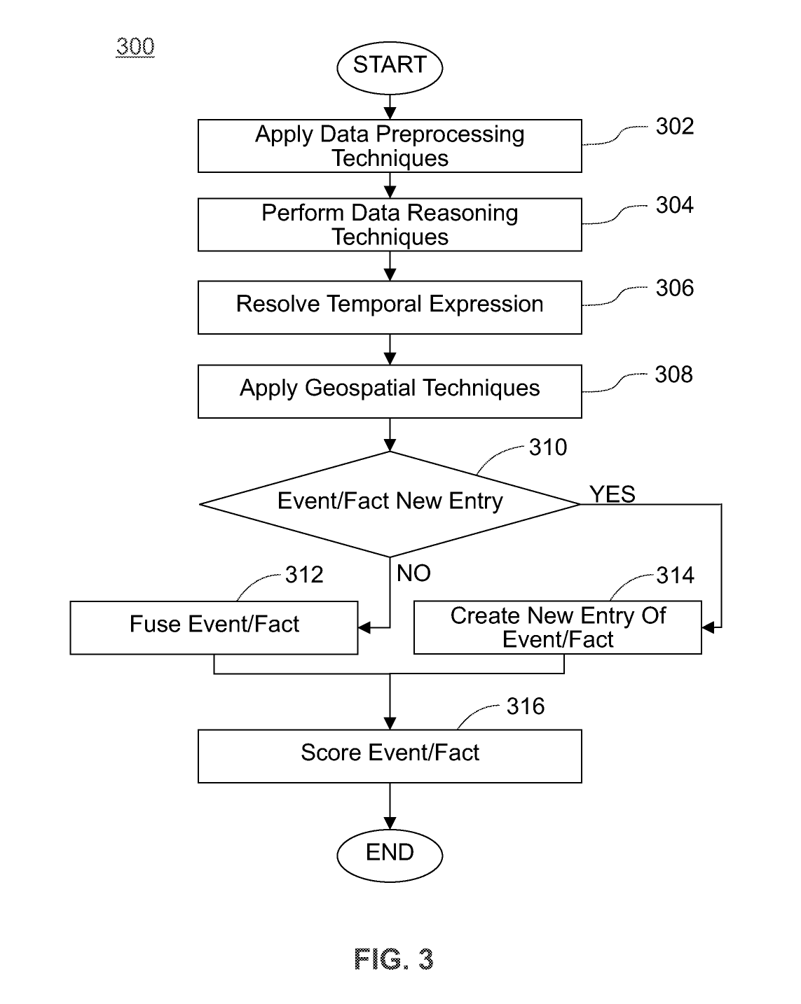

FIG. 3 depicts flowchart 300 of structured data source function 120, a function of geospatial program 104, executing within the computing environment 100 of FIG. 1, in accordance with an embodiment of the present invention. Structured data source function 120 extracts data from structured data source 110 and performs preprocessing, cleaning, and normalization techniques, then applies data reasoning techniques to detect temporal information from events and/or facts. Structured data source function 120 applies geospatial reasoning to merge similar facts and events and score the events or facts.

In step 302, structured data source function 120 performs preprocessing techniques to events or facts of structured data source 110. In one embodiment, structured data source function 120 performs a preprocessing to events or facts of structured data source 110. Preprocessing is a step in a data mining process where out of range values, impossible data combinations, missing values, etc., are removed from a structured data source 110 to allow a faster analysis of the events or facts. In one embodiment, structured data source function 120 performs a cleaning and normalization to events or facts of structured data source 110. A cleaning process can detect, correct, and/or remove corrupt or inaccurate records from structured data source 110. Data normalization reduces data to canonical form, organizing fields and tables of structured data source 110 to minimize redundancy and dependency. In one embodiment, structured data source function 120 performs only a cleaning process on structured data source 110. In other embodiments, structured data source function 120 performs a combination of cleaning, normalization, and other preprocessing techniques to remove unnecessary, corrupt, repeat, or otherwise non-beneficial events or facts of structured data source 110.

In step 304, structured data source function 120 performs data reasoning techniques to the identified event or fact of structured data source 110. Structured data source function 120 also gathers information from other structured data source 110 such as GIS and domain ontology to assist in extracting relevant data for the event or fact from structured data source 110. Structured data source function 120 may gather information from other structured data source 110 by performing keyword analysis, machine learning, and/or utilizing other forms of technologies that gather data, analyze data, and extract data from data sources. In one embodiment, structured data source function 120 only uses structured data source 110 as a data source from which to extract events or facts. In other embodiments, structured data source function 120 may use additional structured data sources as data sources from which to extract events or facts.

In step 306, structured data source function 120 resolves temporal expressions in facts and/or events of structured data source 110. For example, structured data source function 120 can link time expressions in identified events and/or facts from structured data source 110 to a calendar date (e.g., “yesterday”, “today”, “last week”, etc.) that is relevant to when the identified events and/or facts were created. In one embodiment, structured data source function 120 resolves temporal expression in events and/or facts by using user defined procedures to resolve the temporal expressions from structured data source 110. In other embodiments, structured data source function 120 uses machine learning techniques to resolve the temporal expressions in facts and/or events of structured data source 110 or a combination of machine learning techniques and user defined procedures.

In step 308, structured data source function 120 applies geospatial techniques to events and/or facts in structured data source 110 to delimit a region of the location of the event. This location or geographical feature can be actual physical entities or events or can represent features of events and/or facts. Features include, for example, the location of an accident on a highway or a street closing due to a festival in the area. While the event and/or fact does not have a defined location, the features of the area can be used to give an approximation of the event and/or fact. In one embodiment, structured data source function 120 performs geospatial techniques with a set of coordinates defining the coverage region in a map of the event. In one embodiment, structured data source function 120 uses a GIS to locate the event. In one embodiment, structured data source function 120 used geospatial metadata that is associated with an event or fact. In another embodiment, structured data source function 120 uses longitude and latitude to give more specific coordinates of the event. In other embodiments, structured data source function 120 uses other forms of geospatial recognition technology to locate the location, region, area, or boundaries of the event of structured data source 110 based on operator requirements.

In decision 310, structured data source function 120 searches database 106 for an event and/or fact that is similar to the current event or fact of a structured data source 110. In one embodiment, structured data source function 120 uses a keyword search technique to search database 106 for an event or fact of either a structured data source 110 or a structured data source 110. In one embodiment, structured data source function 120 only searches through either structured data source 110 or unstructured data source 112, but not both. In one embodiment, structured data source function 120 has a minimum keyword value associated with a comparison of events and facts in database 106 in order to determine if the current event or fact is new or a duplicate of an already existing event or fact. If structured data source function 120 determines that the event or fact is not a new entry, structured data source function 120 combines the event or fact with the previously stored entry (see step 312). If structured data source function 120 determines that the fact or event is a new entry, geospatial program creates a new entry (see step 314).

In step 312, structured data source function 120 combines the current event or fact of structured data source 110 with an event or fact of database 106. In one embodiment, structured data source function 120 combines the event and/or fact that is being analyzed with the event and/or fact that has been identified as being reflective of the event and/or fact that is currently stored in database 106. In one embodiment, structured data source function 120 may combine many events or facts considered to correspond to existing entries into a single event or fact within database 106. In one embodiment, structured data source function 120 only combines events or facts of structured data source 110 upon receiving permission from an operator. In other embodiments, structured data source function 120 combines only portions of events or facts of structured data source 110 that structured data source function 120 determines are not new entries. In one embodiment, structured data source function 120 deletes the event or fact, rather than merging the events or facts with corresponding events or facts already in database 106.

In step 314, structured data source function 120 creates a new entry in database 106. In one embodiment, structured data source function 120 creates a new event or fact in database 106 that contains all the relevant data regarding the event or fact that was analyzed. The information may include, for example, geospatial information, temporal information, or any other information that is important for geospatial program 104 to access this event and/or fact. In one embodiment, structured data source function 120 requires operator confirmation prior to creating a new event or fact of a structured data source 110 in database 106. In other embodiments, structured data source function 120 stores the new entry in another database or location.

In step 316, structured data source function 120 assigns a score or confidence factor to each event or fact that is either merged with an already existing event or fact in database 106 or to each new event or fact that is added to database 106. In one embodiment, this score or confidence factor indicates a likelihood of accuracy of information. In one embodiment, structured data source function 120 scores or applies a confidence factor to each event or fact to create a hierarchy of events or facts within database 106. This hierarchy is used by geospatial program 104 to access events or facts that are more relevant, accurate, or appear more frequently quicker. In one embodiment, geospatial program 104 will use events or facts with a higher score first, resulting in a more efficient search through database 106. In one embodiment, structured data source function 120 scores the event or fact with the use of logistic regression. In one embodiment, structured data source function 120 bases the score of the event or fact on the uncertainty of structured data source 110. The uncertainty of structured data source 110 is based on the accuracy and reliability of the source creating the data that comprises structured data source 110. In other embodiments, structured data source function 120 determines a score of an event or fact by the frequency or number of occurrences of the event or fact in database 106, reputation of structured data source 110, corroboration of data, number of similar reports, accuracy of methods used in the data extraction process, amount of detail in the reports, and/or other factors. In one embodiment, structured data source function 120 automatically stores events or facts in database 106, regardless of score or confidence factor. Structured data source function 120 adjusts the score or confidence factor based off the redundancy or occurrences of the event or fact that are already stored in database 106. In one embodiment, structured data source function 120, has a minimum score that, if failed to be met, results in structured data source function 120 refraining from adding the corresponding event or fact to database 106. In another embodiment, structured data source function 120, has a minimum score that, if failed to be met, results in structured data source function 120 adding the event or fact to database 106, and structured data source function 120 will also send an alert or warning to an operator to, for example, inform the operator of the new event or fact added to database 106.

FIG. 4 depicts a block diagram 400 of components of servers 102, 116, and 118, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Servers 102, 116, and 118 include communications fabric 402, which provides communications between computer processor(s) 404, memory 406, persistent storage 408, communications unit 410, and input/output (IO) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In one embodiment, memory 406 includes random access memory (RAM) and cache memory 416. In general, memory 406 can include any suitable volatile or non-volatile computer-readable storage media.

Geospatial program 104, database 106 is stored for execution by one or more of the respective computer processors 404 of servers 102, 116, and 118 via one or more memories of memory 406 of servers 102, 116, and 118. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in the examples, provides for communications with other data processing systems or devices, including servers 102, 116, and 118. In the examples, communications unit 410 includes one or more network interface cards. Communications unit 410 may provide communications through the use of either or both physical and wireless communications links. Geospatial program 104 may be downloaded to persistent storage 408 of servers 102, 116, and 118 through communications unit 410 of servers 102, 116, and 118.

I/O interface(s) 412 allows for input and output of data with other devices that may be connected to servers 102, 116, and 118. For example, I/O interface(s) 412 may provide a connection to external device(s) 418 such as a keyboard, keypad, camera, a touch screen, and/or some other suitable input device. External device(s) 418 can also include portable computer-readable storage media such as, for example, thumb drives, portable optical or magnetic disks, and memory cards. Software and data used to practice embodiments of the present invention, e.g., function of Geospatial program 104 can be stored on such portable computer-readable storage media and can be loaded onto persistent storage 408 of servers 102, 116, and 118 via I/O interface(s) 412 of servers 102, 116, and 118. Software and data used to practice embodiments of the present invention, e.g., Geospatial program 104 can be stored on such portable computer-readable storage media and can be loaded onto persistent storage 408 of servers 102, 116, and 118 via I/O interface(s) 412 of servers 102, 116, and 118. I/O interface(s) 412 also connect to a display 420.

Display 420 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams and combinations of blocks in the flowchart illustrations and/or block diagrams can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for extracting geospatial temporal facts and events, the method comprising:
receiving, by one or more processors, a set of structured data and a set of unstructured data;
extracting, by one or more processors, a first set of temporal information and a first set of geospatial information from the set of unstructured data;
identifying, by one or more processors, a second set of temporal information and a second set of geospatial information from the set of structured data;
determining, by one or more processors, that the set of structured data and the set of unstructured data are related, based on at least the first set of temporal information, the second set of temporal information, the first set of geospatial information, and the second set of geospatial information;
grouping, by one or more processors, the set of structured data and the set of unstructured data into a collective set of data; and
storing, by one or more processors, the collective set of data.

2. The method of claim 1, further comprising:
associating, by one or more processors, a confidence factor to the collective set of data, wherein the confidence factor indicates a likelihood of accuracy of information comprising the collective set of data.

3. The method of claim 1, wherein the confidence factor is based on factors selected from the group consisting of reputation of data source, corroboration of data, and frequency of similar data occurrences.

4. The method of claim 1, further comprising:
determining, by one or more processors, that the collective set of data is related to a previously stored set of data; and
grouping, by one or more processors, the previously stored set of data with the collective set of data.

5. The method of claim 4, further comprising:
adjusting, by one or more processors, the confidence factor based on information from the previously stored set of data.

6. The method of claim 1, wherein determining that the set of structured data and the set of unstructured data are related is further based on a first topic of the set of unstructured data and a second topic of the set of structured data.

7. The method of claim 1, wherein extracting the first set of temporal information and the first set of geospatial information from the set of unstructured data includes applying, by one or more processors, natural language processing to text of the set of unstructured data.

8. A computer program product for extracting geospatial temporal facts and events, the computer program comprising:
one or more computer readable storage media and program instructions stored on the one or more computer readable storage media, the program instructions comprising:
program instructions to receive a set of structured data and a set of unstructured data;
program instructions to extract a first set of temporal information and a first set of geospatial information from the set of unstructured data;
program instructions to identify a second set of temporal information and a second set of geospatial information from the set of structured data;
program instructions to determine that the set of structured data and the set of unstructured data are related, based on at least the first set of temporal information, the second set of temporal information, the first set of geospatial information, and the second set of geospatial information;
program instructions to group the set of structured data and the set of unstructured data into a collective set of data; and
program instructions to store the collective set of data.

9. The computer program product of claim 8, further comprising:
program instructions, stored on the one or more computer readable storage media, to associate a confidence factor to the collective set of data, wherein the confidence factor indicates a likelihood of accuracy of information comprising the collective set of data.

10. The computer program product of claim 8, wherein the confidence factor is based on factors selected from the group consisting of reputation of data source, corroboration of data, and frequency of similar data occurrences.

11. The computer program product of claim 8, further comprising:
program instructions, stored on the one or more computer readable storage media, to determine that the collective set of data is related to a previously stored set of data; and
program instructions, stored on the one or more computer readable storage media, to group the previously stored set of data with the collective set of data.

12. The computer program product of claim 11, further comprising:
program instructions, stored on the one or more computer readable storage media, to adjust the confidence factor based on information from the previously stored set of data.

13. The computer program product of claim 8, wherein program instructions to determine that the set of structured data and the set of unstructured data are related are further based on a first topic of the set of unstructured data and a second topic of the set of structured data.

14. The computer program product of claim 8, wherein program instructions to extract the first set of temporal information and the first set of geospatial information from the set of unstructured data include program instructions to apply natural language processing to text of the set of unstructured data.

15. A computer system for extracting geospatial temporal facts and events, the computer system comprising:
one or more computer processors, one or more computer readable storage media, and program instructions stored on the computer readable storage media for execution by at least one of the one or more processors, the program instructions comprising:
program instructions to receive a set of structured data and a set of unstructured data;
program instructions to extract a first set of temporal information and a first set of geospatial information from the set of unstructured data;
program instructions to identify a second set of temporal information and a second set of geospatial information from the set of structured data;
program instructions to determine that the set of structured data and the set of unstructured data are related, based on at least the first set of temporal information, the second set of temporal information, the first set of geospatial information, and the second set of geospatial information;
program instructions to group the set of structured data and the set of unstructured data into a collective set of data; and
program instructions to store the collective set of data.

16. The computer system of claim 15, further comprising:
program instructions, stored on the one or more computer readable storage media for execution by at least one of the one or more processors, to associate a confidence factor to the collective set of data, wherein the confidence factor indicates a likelihood of accuracy of information comprising the collective set of data.

17. The computer system of claim 15, wherein the confidence factor is based on factors selected from the group consisting of reputation of data source, corroboration of data, and frequency of similar data occurrences.

18. The computer system of claim 15, further comprising:
program instructions, stored on the one or more computer readable storage media for execution by at least one of the one or more processors, to determine that the collective set of data is related to a previously stored set of data; and
program instructions, stored on the one or more computer readable storage media for execution by at least one of the one or more processors, to group the previously stored set of data with the collective set of data.

19. The computer system of claim 18, further comprising:
program instructions, stored on the one or more computer readable storage media for execution by at least one of the one or more processors, to adjust the confidence factor based on information from the previously stored set of data.

20. The computer system of claim 15, wherein program instructions to extract the first set of temporal information and the first set of geospatial information from the set of unstructured data include program instructions to apply natural language processing to text of the set of unstructured data.
